(19) United States
(12) Patent Application Publication
(10) Pub. No.: US 2005/0172173 A1
(43) Pub. Date: Aug. 4, 2005

(54) Apparatus and method for monitoring system status in an embedded system

(76) Inventor: John Michael Page, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/759,999

(22) Filed: Jan. 16, 2004

(51) Int. Cl. G06F 11/00

(52) U.S. Cl. 714/39

(57) ABSTRACT

A method and system for monitoring a headless embedded system. The method starts by identifying programs to be monitored, a delta time within which the program is supposed to check-in, and at least one remedial action to be taken in the event the program fails to check-in within the delta time. For each identified program the method and system periodically determine whether the time of the last check-in is greater than a current time minus the delta time. When the time of the last check-in for any identified program is less than a current time minus the delta time for that identified program executing a remedial action associated with that program.

### BACKGROUND OF THE INVENTION

Embedded systems, e.g. computers that are components in larger systems and rely on their own microprocessor, are becoming commonplace. For example, embedded systems are being used in personal electronic items such as PDAs, inkjet printers, cell phones, and car radios. Embedded systems are also becoming critical components of many industrial devices such as test and measurement systems, including the AGILENT TECHNOLOGIES J6802A and J6805A Distributed Network Analyzers.

To meet this growing demand, operating system providers, such as MICROSOFT, provide embedded versions of their normal operating systems. One of the more recent offerings from MICROSOFT is WINDOWS XP EMBEDDED (referred to herein as XPE). Embedded systems, such as XPE, provide functionality in keeping with the nature of embedded systems, including mechanisms (such as write filters) for protecting critical data, such as the operating system or files from being corrupted.

Embedded systems, much like personal computer systems generally store data in memory and/or mass storage. Mass storage may comprise, for example, a variety of persistent components, including removable and non-removable storage drives such as hard drives and compact flash media. Memory is largely comprised of non-persistent components, such as RAM. The data stored in memory is subject to corruption due to power surges, hard power downs, viruses, and so on. Even though embedded system have functionality, such as write filters, that seek to prevent corruption, they are not always effective.

Corruption can lead to intermittent failures that may compromise the operation of the system. In test and measurement systems, corruption can lead to erroneous test results, incorrect diagnosis and unnecessary repairs and troubleshooting. Typically, the sooner corruption is detected, the lighter the potential damaged caused by the corruption. Many times corrupted data may be cleared from non-persistent components by simply restarting the affected program or by rebooting. Accordingly, it is desirable that the various programs running on an embedded system be monitored to ensure that remedial action can be taken as soon as possible.

In many non-embedded systems, a video display, e.g. a monitor, is provided to facilitate monitoring the operation of the system. By watching the monitor it is possible to detect or predict some error that occur due to corruption. Further, the operating system can be configured to create a display on the monitor warning of error conditions caused by corruption or other factors.

It has become popular to use embedded systems without any form of display, monitor or otherwise. Such embedded systems are often referred to as “headless” systems. Interaction with headless systems, if any, is usually via a communication channel, such as the Internet. An example of a headless system is a distributed test device co-located with network components or other convenient access point. Distributed test devices monitor the component or access point and report the results of the monitoring using the network being monitored or some other communication channel.

Human involvement with headless test system is optimally limited to installation and activation of the system. In general, it is the goal of most embedded systems to be totally autonomous. It is thus desirable that an embedded system not only be reliable, but also self-monitoring. To achieve the goal of being both reliable and self-monitoring, embedded systems, headless or otherwise, should be programmed for the detection of conditions, such as corruption, that can cause the system to operate in a way other than intended. One known method is the use of watchdogs which track the execution of processes and execute some form of action if the watched process should fail. Failure modes include process crashes due to faulty code execution; hanging (failing to progress in a useful way); and deadlocking (stopping execution due to resources being unavailable).

Most known embedded system watchdogs are hardware based and track a single process. The action on failure is typically a reboot. Hardware based watchdogs typically operate by monitoring a specified memory or register location. The location is assigned to the process, which is modified to update the location on a regular basis, termed “checking-in.” If the location is not updated on schedule, the watchdog initiates a reboot.

Unfortunately, hardware based watchdogs only track a single process and, due to their nature, are not available on all computers. Further, the action upon failure is a simple reboot. Accordingly, the present inventors have recognized a need for apparatus and methods for tracking multiple processes and providing flexible actions upon failure.

### BRIEF DESCRIPTION OF THE DRAWINGS

An understanding of the present invention can be gained from the following detailed description of the invention, taken in conjunction with the accompanying drawings of which:

FIG. 1 is a block diagram of an embedded system in accordance with an embodiment of the present invention.

FIG. 2 is a flow chart of a method in accordance with an embodiment of the present invention.

FIG. 3 is a flow chart of a method in accordance with an embodiment of the present invention.

### DETAILED DESCRIPTION

Reference will now be made in detail to the present invention, examples of which are illustrated in the accompanying drawings, wherein like reference numerals refer to like elements throughout. In addition to the described apparatus, the detailed description which follows presents methods that may be embodied by routimes and symbolic representations of operations of data bits within a computer readable medium, associated processors, embedded systems, general purpose personal computers and the like. The methods presented herein are sequences of steps or actions, often executed by a processor or dedicated circuits, leading to a desired result, and as such, encompasses such terms of art as “software,” “routimes,” “computer programs,” “programs,” “objects,” “functions,” “subroutimes,” and “procedures.” These descriptions and representations are the means used by those skilled in the art effectively convey the substance of their work to others skilled in the art.

The methods of the present invention will be described with respect to implementation on a headless embedded computer system using an embedded operating system. Those of ordinary skill in the art will recognize that the apparatus and methods recited herein may also be implemented on embedded systems with monitors and even on general purpose computing devices, with or without monitors. While the present invention will be described as being implemented using PC based devices operating with the MICROSOFT WINDOWS XP EMBEDDED (hereinafter XPE), the apparatus and methods presented herein are not inherently related to any particular device or operating system. Rather, various devices and operating systems may be used in accordance with the teachings herein. Machines that may perform the functions of the present invention include those manufactured by such companies as AGILENT TECHNOLOGIES and HEWLETT PACKARD as well as other manufacturers of embedded systems and general computing devices.

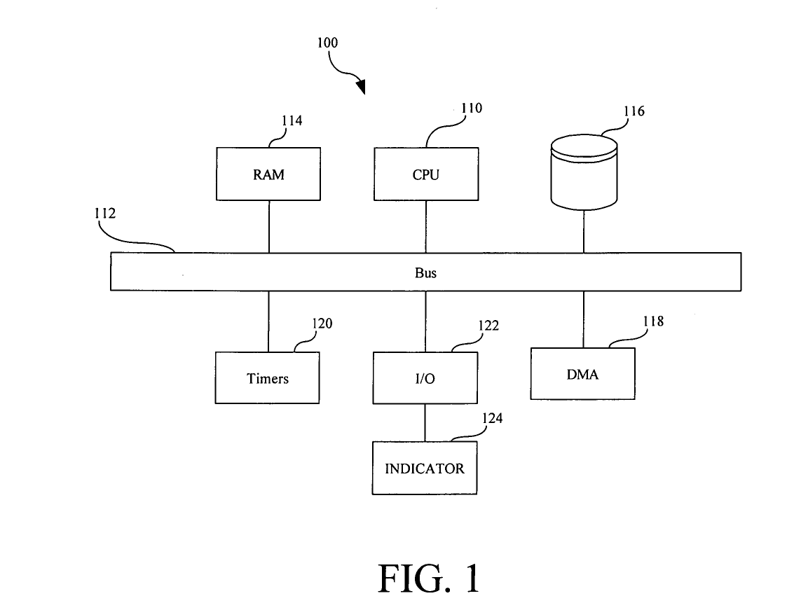

FIG. 1 is a block diagram of an embedded system 100 in accordance with an embodiment of the present invention. The embedded system 100 generally comprises: a CPU 110 connected by a bus 112 to: RAM 114; disk storage 116; DMA (direct memory access) controller 118; timers 120; and an I/O subsystem 122. The disk storage 116 stores the operating system along with programs and data and may be divided into a plurality of partitions. The embedded system 100 shown in FIG. 1 lacks a monitor and, as such, is a headless system.

An indicator 124, connected to the I/O subsystem 122, provides an indication that the embedded system is operational in addition to being ON. Preferably, but not necessarily, this indication takes the form of a two color light emitting diode wherein one color is illuminated when certain conditions, generally reflective of an operational system, are present and a second color with the conditions are not present—generally indicating a non-operational system. A suitable indicator and control circuitry therefore is described in co-pending U.S. patent application Ser. No. 10/726,769 entitled APPARATUS AND METHOD FOR INDICATING SYSTEM STATUS IN AN EMBEDDED SYSTEM. The '769 applications is assigned to the assignee of the present application and incorporated herein by reference.

It is to be noted that the block diagram shown in FIG. 1 has been simplified to avoid obscuring the present invention. Functional components have been left out or conveniently combined with other functional components selected for inclusion in FIG. 1. Further, the block diagram shown in FIG. 1 is but one of many architectures upon which the present invention may be practiced. Specifically, the architecture show in FIG. 1 is sometimes termed the “PC architecture” because it resembles an early personal computer. This architecture was chosen for describing the present invention, as it is universally recognizable to those of ordinary skill in embedded system design.

The present invention generally comprises a software-based watchdog comprising two parts: a registration procedure; and a watchdog program. The registration procedure facilitates registering programs to be watched (the “watched programs,” “registered programs,” or “identified programs”) and the performing of confirmation actions by the watched programs. The watchdog procedure checks for the periodic completion of the confirmation actions by the watched programs and, upon the failure to complete a confirmation action executes defined remedial actions. In accordance with at least one preferred embodiment implemented using XPE, the registration procedure is provided in a dynamic linked library file (dll) while the watchdog procedure is embodied by a service.

In accordance with perhaps the preferred embodiment, the registration procedure provides for at least three functions: register; check-in; and unregister. The register function permits a program to register with the watchdog and pass various parameters including how often the watchdog should expect the program to check in (the delta time) and what action or actions are to be taken if the program fails to check in (the remedial action(s)). The check-in function simply passes a time stamp to a common memory location to serve as the confirmation action. The unregister function removes the program from the watchdog's list of programs being watched.

The watchdog procedure periodically walks through the list of registered programs and, for those programs requiring service (as defined by the delta time) checks the memory location for the timestamp recorded by the check-in function. When the timestamp plus the delta time is less than the current time, it is deemed that a failure has occurred. The watchdog procedure logs the failure and takes a specified remedial action.

In one embodiment, remedial actions comprise executable files that are called by the watchdog procedure. In perhaps the preferred embodiment, the register function passes the watchdog procedure an array designating a series of executable files. It is also possible to simply pass a pointer to the array. The watchdog procedure maintains a counter, which can be implemented as part of the pointer, which is incremented each time a registered program fails a check. Upon the detection of a failure, an executable file from the array, selected using the counter, is executed. For example, upon the first failure the first executable file in the array is executed; upon the second failure the second executable file in the array is executed; etc. . . . This allows different remedial actions to be taken each sequential time the registered program fails. For example: the first failure could result in the program being restarted; the second failure could result in a system restart; and the third failure could result in a system shutdown.

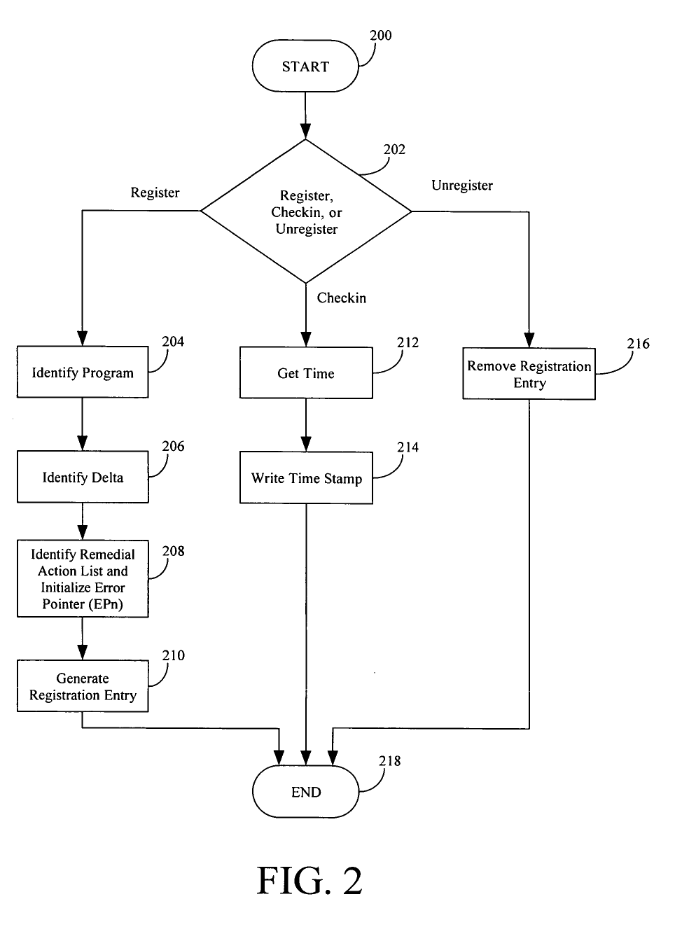

FIG. 2 is a flow chart of a method in accordance with an embodiment of the present invention. More specifically, FIG. 2 is a method implementing one embodiment of the registration procedure. As noted, the registration procedure may be implemented as a dynamic linked library when the selected operating system is XPE.

The method starts in step 200 when a program (application, system or otherwise) seeking service calls the routimes of the present method. In accordance with at least one embodiment, routimes embodying the present method are contained in a common dynamic linked library with offers three services: Register; Check-in; and Unregister. In step 202 a determination is made as to which of the three services is being requested.

When registration service is requested, the method proceeds to step 204 wherein the program requesting registration is identified. Subsequently, in step 206, a delta time is identified. The delta time is the maximum allowable time allowed for the program to check-in. Next in step 208, a remedial action list is identified and a pointer to the list, termed the error pointer EPn, is initialized to zero.

In at least the present embodiment, the remedial action list is an array containing identifiers of executables, one of which is to be executed each time the program fails to check-in within the delta time. Each time a remedial action is needed, the error pointer is increased by one and the next executable in the remedial action list is executed. It is envisioned that the executable will instruct the system to take increasingly sever measures. For example the first action could comprise shutting down and restarting the program. The second and third actions could simply be restarting the entire system, while the fourth action could be shutting the system down for maintenance.

In step 210, a registration entry is generated. In perhaps the preferred embodiment, the registration entry is a key in the XPE registry. The key could contain, for example, the program name, the delta time, the location of the remedial action list and a pointer into the list. In general, the information required to create the registration entry can be passed to the routime by the calling program (thereby constituting the steps of identifying). It may also be beneficial at this time to add a time stamp to the registration entry as a first check-in service. Alternatively, a request for check-in service can be issued immediately upon completion of the register service. The registration service thereafter ends in step 218 and the program initiating the registration service is now a watched program.

If, back in step 202, check-in service was requested by a watched program, the method proceeds to step 212 and the current system time is retrieved. Subsequently, in step 214, a time stamp is written to a location associated with the registration entry. Each time the check-in service is called, the time stamp is over written with the then current time. The watched program should be programmed to repeatedly call the check-in service within the delta time. The check-in service thereafter ends in step 218.

If, back in step 202, the remove registration service was requested, the method proceeds to step 216, and the registration entry is removed. In the present embodiment, this is accomplished by simply deleting the registry key in XPE. The remove registration service thereafter ends in step 218 and the program requesting the remove registration service is no longer a watched program.

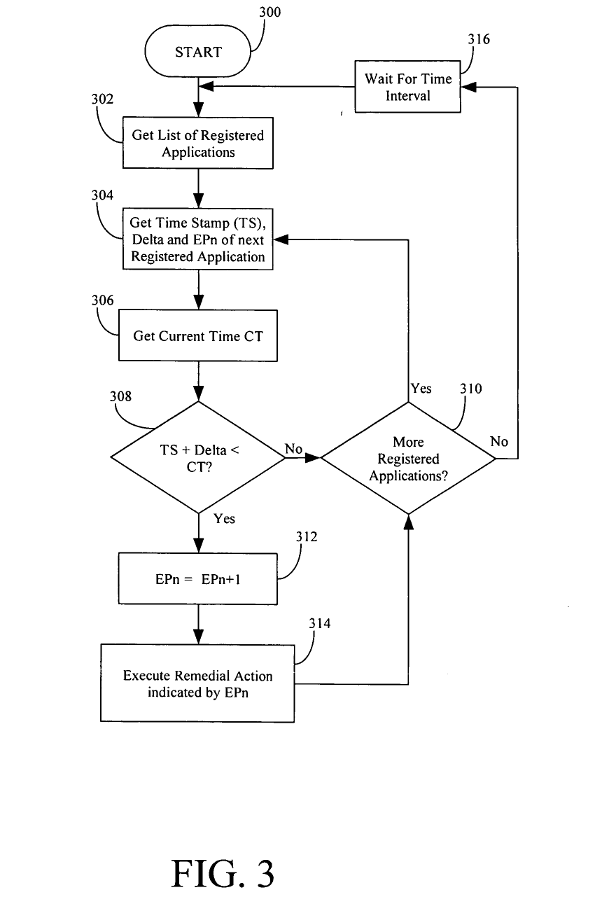

FIG. 3 is a flow chart of a method in accordance with an embodiment of the present invention. More specifically, FIG. 3 is a method implementing an embodiment of the watchdog program. As noted, the watchdog program may be implemented as a service when the selected operating system is XPE.

The method starts in step 300 upon being invoked, preferably as part of a startup routime. In step 302, a list of programs currently registered, for example using the registration procedure described with respect to FIG. 2, is obtained. In the case of the embodiment described with respect to FIG. 2, the list of registered program can be retrieved using standard XPE registry commands. Once the list has been retrieved, or at least a pointer has been created and set at the start of the list, each entry in the list is checked in a loop comprising steps 304 through 310.

In step 304, the time stamp (TS), delta, and error pointer (EPn) of next entry (the first entry if this is the first pass) is retrieved. Next, in step 306 the current time (CT) is retrieved. In step 308 the sum of the time stamp associated with the entry and the delta associated with the entry is compared to the current time. If the sum is greater than the current time, the program is deemed to be operating correctly and the method goes to step 310 to check if there are more watched programs to check. If unchecked watched programs remain, the method returns to step 304 and the time stamp (TS), delta, and error pointer (EPn) of next entry is retrieved.

If in step 308, the sum of the time stamp and the delta is less than the current time, the watched program has failed to timely request a check-in and the method proceeds to step 312. In step 312, the error pointer for the subject watched program (EPn) is incremented by 1. Next in step 314, the remedial action pointed to by the error pointer is undertaken. Optionally, a log of the failure and the remedial action can be made. Upon completion of the remedial action, the method goes to step 310 and to check if there are more watched programs to check. If any watched programs remain to be checked the method returns to step 304 and the time stamp (TS), delta, and error pointer (EPn) of next entry is retrieved.

Once all watched program have been checked, the method proceeds to step 316 where the methods waits for a prescribed interval prior to returning to step 302 to recheck the watched programs.

It will be appreciated by those skilled in the art that changes may be made to the above described embodiment without departing from the principles and spirit of the invention, the scope of which is defined in the claims and their equivalents. For example, the error pointer (EPn) can be reset after the expiration of a certain period of time, for example once a day. Alternatively, one for every X (e.g., 100) successful and uninterrupted check-ins the error pointer could be reduced. Optionally, any reduction or resetting of the counter can be logged.

By way of further example, Tables 1 through 4 present source code, compatible with XPE, implementing certain features of the present invention. In this implementation, the only remedial action is a system restart. Further, this implementation uses a LED indicator on the embedded system to communicate system status with an operator. One implementation of an LED indicator is discussed in co-pending U.S. patent application Ser. No. 10/726,769 incorporated herein by reference.

TABLE 1
AgentWatchDogCommon.h

#if !defined(AFX_AGENTWATCHDOGCOMMON_H)
#define AFX_AGENTWATCHDOGCOMMON_H
#include “TCHAR.H”
#include <time.h>
#define MAXAWDLOG 50000
const TCHAR
WATCHDOG[] = _T(“SOFTWARE\\Agilent\\AgentWatchDog”);
const TCHAR TIMESTAMP[] = _T(“LastStamp”);
const TCHAR TIMEDELTA[] = _T(“Delta”);
const TCHAR REBOOTRETRY[] = _T(“MaxRebootRetry”);
#define AWDMaxAppID 80
#endif //!defined(AFX_AGENTWATCHDOGCOMMON H)

TABLE 2
AgentWatchDogDll.cpp

```
// AgentWatchDogDll.cpp : Defines the entry point for the DLL application.
//
#include “stdafx.h”
#include “AgentWatchDogDll.h”
// register should be called once at the start of your application
// strAppID is any unique identifier for your application (typically its
name)
// nDelta is how long in minutes the wtchdog should wait for your application
// to call AWDTimestamp before deciding the app is dead and rebooting the box
AGENTWATCHDOGDLL_API UINT AWDRegsiter(char* strAppID, UINT nDelta, UINT
nRetryReboot) {
  if (strlen(strAppID)+1 >= AWDMaxAppID)
    strAppID[AWDMaxAppID−1] = NULL;
  UINT nReturnCode = AWDSuccess;
    HKEY hkTheKey;
  HKEY hkWDKey;
    DWORD dwDisposition;
  DWORD dwResult;
  DWORD nDeltaSeconds = nDelta*60;
  time_t currentTime;
  time(&currentTime);
  DWORD dwTime = currentTime;
  dwResult = RegCreateKeyEx( HKEY_LOCAL _MACHINE, WATCHDOG, 0,REG_NONE,
    REG_OPTION_VOLATILE,
                  KEY_WRITE|KEY_READ, NULL, &hkTheKey,
&dwDisposition);
  if ( dwResult == ERROR_SUCCESS ) {
    dwResult = RegCreateKeyEx( hkTheKey, strAppID, 0,REG_NONE,
    REG_OPTION_VOLATILE,
              KEY_WRITE|KEY_READ, NULL, &hkWDKey,
      &dwDisposition);
      if ( dwResult == ERROR _SUCCESS ) {
        if ( dwDisposition == REG_OPENED_EXISTING_KEY )
          nReturnCode = AWDAlreadyRegistered;
        if ( RegSetValueEx( hkWDKey, TIMEDELTA, NULL, REG_DWORD,
(CONST BYTE*)&nDeltaSeconds, sizeof(DWORD) )
          != ERROR_SUCCESS ) {
          // error message
          nReturnCode = AWDFailed;
        }
        if ( RegSetValueEx( hkWDKey, TIMESTAMP, NULL, REG_DWORD,
(CONST BYTE*)&dwTime, sizeof(DWORD) )
          != ERROR_SUCCESS) {
          // error message
          nReturnCode = AWDFailed;
        }
        if ( RegSetValueEx( hkWDKey, REBOOTRETRY, NULL, REG_DWORD,
(CONST BYTE*)&nRetryReboot, sizeof(UINT) )
          != ERROR_SUCCESS ) {
          // error message
          nReturnCode = AWDFailed;
        }
      RegCloseKey(hkWDKey);
    } else {
      // error message
      nReturnCode = AWDFailed;
    }
    RegCloseKey(hkTheKey);
  } else {
    // error message
    nReturnCode= AWDFailed;
  }
  return nReturnCode;
}
// Unregister should be called if your application exits normally and does
// not want the watchdog to reboot the box because your app ended
AGENTWATCHDOGDLL_API UINT AWDUnregsiter(char* strAppID) {
  if (strlen(strAppID)+1 >= AWDMaxAppID)
    strAppID[AWDMaxAppID−1] = NULL;
  UINT nReturnCode = AWDSuccess;
    HKEY hkTheKey;
  DWORD dwDisposition;
  DWORD dwResult;
  dwResult = RegCreateKeyEx( HKEY_LOCAL_MACHINE, WATCHDOG, 0,REG_NONE,
    REG_OPTION_VOLATILE,
                  KEY_WRITE|KEY_READ, NULL, &hkTheKey,
&dwDisposition);
  if( dwResult == ERROR_SUCCESS ) {
    if ( dwDisposition == REG_OPENED_EXISTING_KEY ) {
        if (RegDeleteKey(hkTheKey, strAppID) != ERROR_SUCCESS)
          nReturnCode = AWDNotRegistered;
    } else {
      nReturnCode = AWDNotRegistered;
    }
    RegCloseKey(hkTheKey);
  } else {
    // error message
    nReturnCode = AWDFailed;
  }
  return nReturnCode;
}
// Timestamp should be called at least every nDelta minutes to keep the
// watchdog from deciding your app has gone awol
AGENTWATCHDOGDLL_API UINT AWDTimeStamp(char* strAppID) {
  if (strlen(strAppID)+1 >= AWDMaxAppID)
    strAppID[AWDMaxAppID−1] = NULL;
  UINT nReturnCode = AWDSuccess;
    HKEY hkTheKey;
  HKEY hkWDKey;
  DWORD dwDisposition;
  DWORD dwResult;
  time_t currentTime;
  time(&currentTime);
  DWORD dwTime = currentTime;
  dwResult = RegCreateKeyEx( HKEY_LOCAL_MACHINE, WATCHDOG, 0,REG_NONE,
    REG_OPTION_VOLATILE,
                    KEY WRITE|KEY READ, NULL, &hkTheKey,
&dwDisposition);
  if( dwResult == ERROR_SUCCESS ) {
    if ( dwDisposition == REG_OPENED_EXISTING_KEY ) {
      if( RegOpenKeyEx(hkTheKey, strAppID, 0L, KEY_SET_VALUE, &hkWDKey) ==
ERROR_SUCCESS) {
        if (RegSetValueEx( hkWDKey, TIMESTAMP, NULL, REG_DWORD,
(CONST BYTE*)&dwTime, sizeof(DWORD) ) )
          nReturnCode = AWDFailed;
        RegCloseKey(hkWDKey);
      } else {
        nReturnCode = AWDNotRegistered;
      }
    } else {
      nReturnCode = AWDNotRegistered;
    }
    RegCloseKey(hkTheKey);
  } else {
    // error message
    nReturnCode = AWDFailed;
  }
  return nReturnCode;
}
```

TABLE 3
AgentWatchDogDll.h

// The following ifdef block is the standard way of creating macros which
make exporting
// from a DLL simpler. All files within this DLL are compiled with the
AGENTWATCHDOGDLL_EXPORTS
// symbol defined on the command line. this symbol should not be defined on
any project
// that uses this DLL. This way any other project whose source files include
this file see
// AGENTWATCHDOGDLL_API functions as being imported from a DLL, wheras this
DLL sees symbols
// defined with this macro as being exported.
#ifdef AGENTWATCHDOGDLL_EXPORTS
#define AGENTWATCHDOGDLL_API _{——}declspec(dllexport)
#else
#define AGENTWATCHDOGDLL_API _{——}declspec(dllimport)
#endif
#include “AgentWatchDogCommon.h”
#define AWDSuccess 0;
#define AWDNotRegistered 1;
#define AWDAlreadyRegistered 2;
#define AWDFailed 3
// register should be called once at the start of your application
// strAppID is any unique identifier for your application (typically its
name)
// nDelta is how long in minutes the watchdog should wait for your
application
// to call AWDTimestamp before deciding the app is dead and rebooting the box
// nReebootRetry is the max number of rebbots that should be done in a 24
hour period
// before giving up
// Return Codes: AWDSuccess, AWDAlreadyRegistered, AWDFailed
AGENTWATCHDOGDLL_API UINT AWDRegsiter(char* strAppID, UINT nDelta = 5, UINT
nRetryReboot = 5);
// Unregister should be called if your aplication exits normally and does
// not want the watchdog to reboo the box because your app ended
// Return Codes: AWDSuccess, AWDNotRegistered, AWDFailed
AGENTWATCHDOGDLL_API UINT AWDUnregsiter(char* strAppID);
// Timestamp should be called at least every nDelta minutes to keep the
// watchdog from deciding your app has gone awol
// Return Codes: AWDSuccess, AWDNotRegistered, AWDFailed
AGENTWATCHDOGDLL_API UINT AWDTimeStamp(char* strAppID);

TABLE 4
AgentWatchDog.cpp

```
// AgentWatchDog.cpp : Defines the entry point for the application.
//
#include “afx.h”
#include “stdafx.h”
#include “AgentWatchDogCommon.h”
#include “AutoRunCommon.h”
/* ----Prototypes of Inp and Outp used for LED control--- */
short _stdcall Inp32(short PortAddress);
void _stdcall Out32(short PortAddress, short data);
LPVOID GetSysErrorMsg(DWORD dwErrCode)
{
    //
    // LocalFree( ) must be used on the returned pointer to free the memory
    // allocated by FormatMessage( )
    //
    LPVOID lpMsgBuf;
    FormatMessage(
        FORMAT_MESSAGE_ALLOCATE_BUFFER |
        FORMAT_MESSAGE_FROM_SYSTEM |
        FORMAT_MESSAGE_IGNORE_INSERTS,
        NULL,
        dwErrCode,
        MAKELANGID(LANG_NEUTRAL, SUBLANG_DEFAULT), // Default language
        (LPTSTR) &lpMsgBuf,
        0,
        NULL
    );
    return lpMsgBuf;
}
void LogToFile(CString strLogData) {
    TRY {
      CString strLogPath;
      if(IsRackMount( )) {
        DWORD nDataSize = 128;
        char strSystemDir[128];
          HKEY hWFKey;
        // Attempt to get the directory info from the registry
        if( RegOpenKeyEx( HKEY_LOCAL_MACHINE, PLATFORM,
                          0, KEY_READ, &hWFKey ) == ERROR_SUCCESS) {
          // read the entry
            if( RegQueryValueEx(hWFKey, SYSTEMDIR, 0, NULL, (unsigned
char*)strSystemDir,
                              &nDataSize) != ERROR_SUCCESS) {
          }
        RegCloseKey(hWFKey);
        } else {
          strcpy(strSystemDir, SYSTEMDIRDEFAULT);
        }
        strLogPath = strSystemDir;
      } else{
        // Get executable directory
        char szPathName[_MAX_PATH];
        GetModuleFileName( NULL, szPathName, sizeof( szPathName ) );
        char* cptr = strrchr( szPathName, ‘\\’ );
        if ( cptr )
          *cptr = 0x0;
        strLogPath = szPathName;
        }
        strLogPath = strLogPath + “\\AgentWatchDog.log”;
        CFile logFile( strLogPath,
                CFile::modeCreate |  CFile::modeNoTruncate |
CFile::modeReadWrite | CFile::shareDenyWrite );
        logFile.SeekToBegin( );
        UINT nCurrentWriteOffset = 0;
        UINT nBytesRead = logFile.Read(&nCurrentWriteOffset,
sizeof(nCurrentWriteOffset));
        // if new file or need to loop; reset offset
        if ((nBytesRead < sizeof(nCurrentWriteOffset)) ∥
            (nCurrentWriteOffset > MAXAWDLOG)) {
          nCurrentWriteOffset = sizeof(nCurrentWriteOffset);
        logFile.SeekToBegin( );
        logFile.Write( &nCurrentWriteOffset,
sizeof(nCurrentWriteOffset));
        }
        logFile.Seek( nCurrentWriteOffset, CFile::begin );
        CTime thetime = CTime::GetCurrentTime( );
        CString strBuffer;
        strBuffer = thetime.Format(“%c”);
        strBuffer += “: ”;
        strBuffer += strLogData;
        strBuffer += ‘\r’;
        strBuffer += ‘\n’;
      logFile.Write(strBuffer.GetBuffer(0), strBuffer.GetLength( ));
      nCurrentWriteOffset += strBuffer.GetLength( );
      logFile.SeekToBegin( );
      logFile.Write( &nCurrentWriteOffset, sizeof(nCurrentWriteOffset));
        logFile.Flush( );
      logFile.Close( );
      }
      CATCH (CFileException,e) ; { }
  END_CATCH
}
int APIENTRY WinMain(HINSTANCE hInstance,
```

| | |
|---|---|
| HINSTANCE | hPrevInstance, |
| LPSTR | lpCmdLine, |
| int | nCmdShow) |

```
{
  CString strRebootMsg;
  bool bKeepRunning = true;
    HKEY hWFKey;
  char strSystemDir[80];
  // Attempt to get the directory info from the registry
  DWORD dwResult = RegOpenKeyEx( HKEY_LOCAL_MACHINE, PLATFORM,
                                0, KEY_READ, &hWFKey );
    if ( dwResult == ERROR_SUCCESS) {
    DWORD nDataSize = 80;
    // read the entry
      if( RegQueryValueEx(hWFKey, SYSTEMDIR, 0, NULL, (unsigned
char*)strSystemDir,
                        &nDataSize) != ERROR_SUCCESS) {
        strcpy(strSystemDir, SYSTEMDIRDEFAULT);
      }
      RegCloseKey(hWFKey);
    }
  char strWatchDogIni[128];
  sprintf (strWatchDogIni, “%s%s”, strSystemDir, “\\AgentWatchDog.ini”);
  SYSTEMTIME sysTime;
    GetLocalTime( &sysTime);
  int nLastHour = sysTime.wHour;
  while(bKeepRunning) {
    // do our thing about once a minute
    Sleep(1000*60);
    // if the clock wrapped past midnight clear the file that tracks
reboot counts
      GetLocalTime( &sysTime);
    int nHour = sysTime.wHour;
      if (nHour != nLastHour) { // did hour change?
          if (nHour < nLastHour) { // did we wrap past midnight?
        // delete record of previous reboot counts
        DeleteFile(strWatchDogIni);
      }
          nLastHour = nHour;
      }
    // get current time
    time_t currentTime;
    time(&currentTime);
    DWORD dwTime = currentTime;
    //find executables
      HKEY hkTheKey;
      DWORD dwResult = RegOpenKeyEx(HKEY_LOCAL_MACHINE, WATCHDOG, 0L,
                          KEY_READ|KEY_WRITE, &hkTheKey);
      if (dwResult == ERROR_SUCCESS)
      {
          FILETIME ft;
          int i = 0;
          bool bMoreExecutables = true;
          while(bMoreExecutables && bKeepRunning)
        {
              DWORD nLen = 80;
              char pChar[80];
            LONG lResult = RegEnumKeyEx(hkTheKey, i++,
pChar,&nLen,NULL, NULL, NULL, &ft);
              if (lResult == ERROR_SUCCESS)
          {
                HKEY hkLocalKey;
            DWORD dwLocalResult = RegOpenKeyEx(hkTheKey, pChar,
```

0L,

```
KEY_READ, &hkLocalKey);
            DWORD dwDeltaResult;
                DWORD dwTimeStampResult;
            DWORD dwSize;
            if (dwLocalResult == ERROR_SUCCESS) {
              DWORD dwDelta = 0;
              DWORD dwTimeStamp = 0;
              DWORD dwMaxReboot = 0;
              dwSize = sizeof(DWORD);
              dwDeltaResult = RegQueryValueEx(hkLocalKey,
TIMEDELTA, NULL, NULL, (LPBYTE)&dwDelta, &dwSize);
              dwSize = sizeof(DWORD);
              dwTimeStampResult = RegQueryValueEx(hkLocalKey,
TIMESTAMP, NULL, NULL, (LPBYTE)&dwTimeStamp, &dwSize);
              dwSize = sizeof(DWORD);
              dwTimeStampResult = RegQueryValueEx(hkLocalKey,
REBOOTRETRY, NULL, NULL, (LPBYTE)&dwMaxReboot, &dwSize);
              // Test dwDeltaResult and dwTimeStampResult to be
sure
              if ( dwDeltaResult == ERROR_SUCCESS &&
dwTimeStampResult == ERROR_SUCCESS ) {
                  Out32(888,0); // Ties all of the data bits low
(off) this is need to clear the other LED color
                  Out32(888,4); // Turns the Bit on registar 4
High (on) = Red LED
                // 1st check if
                if (dwTimeStamp + dwDelta < dwTime) {
                  char strRebootCount[10];
                  GetPrivateProfileString( “RebootCounts”,
                                          pChar,
                                              “0”,
strRebootCount,
                                              10,
strWatchDogIni);
                DWORD nRebootCount = atoi(strRebootCount);
                if (dwMaxReboot == 0 ∥ nRebootCount <
dwMaxReboot ) {
                  if (dwMaxReboot != 0) {
                    itoa(nRebootCount+1, strRebootCount,
10);
                    // clear the old record from the file
                      WritePrivateProfileString(
“RebootCounts”,
```

pChar,

NULL,
strWatchDogIni);
WritePrivateProfileString(
“RebootCounts”,

pChar,

```
strRebootCount,
strWatchDogIni);
                  }
                  // Log failure to file
                  CTime LastStampTime((time_t)dwTimeStamp);
                    CString strTimeBuffer;
                    strTimeBuffer =
LastStampTime.Format(“%c”);
                  strRebootMsg.Format(“%s failed to
timestamp; Last Timestamp was at ”, pChar);
                  strRebootMsg += strTimeBuffer;
                  LogToFile(strRebootMsg);
                  bKeepRunning = false;
                }
              }
            } else {
              CString strMsg;
              strMsg.Format(“%s has a malformed registry
entry”, pChar);
              LogToFile(strMsg);
            }
          }
        } else {
              bMoreExecutables = false;
        }
      }
        RegCloseKey(hkTheKey);
    }
  } // while (true);
  // we only get here if some process didn't timestamp appropriately and we
need to re-boot
    HANDLE hMyToken;
    TOKEN_PRIVILEGES tp;
    LUID luid;
    // open the token for our porcess
    if(!OpenProcessToken( GetCurrentProcess( ), TOKEN ADJUST PRIVILEGES,
&hMyToken)) {
      LogToFile(“Failed to OpenProcessTokens”);
    }
  // lookup the LUID for the SE_SHUTDOWN_NAME privilege.
  if(!LookupPrivilegeValue(NULL, SE_SHUTDOWN_NAME, &luid)) {
    LogToFile(“Failed LookupPrivilegeValue”);
    }
    // setup to give ourselves the SE_SHUTDOWN_NAME privilege
    tp.PrivilegeCount = 1;
    tp.Privileges[0].Luid = luid;
    tp.Privileges[0].Attributes = SE_PRIVILEGE_ENABLED;
    if( !AdjustTokenPrivileges(hMyToken, FALSE, &tp,
sizeof(TOKEN_PRIVILEGES), NULL, NULL) ) {
      LogToFile(“Failed AdjustTokenPrivileges”);
    }
    // check if it worked
    if(GetLastError( ) != ERROR_SUCCESS) {
      // LogToFile
    }
  // Reboot!
  LogToFile(“Reboot started”);
  int i = 0;
    while(!InitiateSystemShutdown(NULL, (char*)(LPCTSTR)strRebootMsg, 3,
true, true) && i < 20 )
    {
    LogToFile( “AgentWatchDog - failed InitializeSystemShutDown”);
    LPVOID pErrMsg = GetSysErrorMsg(GetLastError( ));
    LogToFile((char*) pErrMsg);
    LocalFree(pErrMsg);
    Sleep(15000);
    i++;
    }
    Sleep(30000);
  i = 0;
    while(!ExitWindowsEx(EWX_REBOOT | EWX_FORCE, 0) && i < 20)
    {
    LogToFile( “AgentWatchDog - failed InitializeSystemShutDown”);
    LPVOID pErrMsg = GetSysErrorMsg(GetLastError( ));
    LogToFile((char*) pErrMsg);
    LocalFree(pErrMsg);
    Sleep(15000);
    i++;
    }
  // if we haven't rebooted by now, give up
  return 0;
}
```

Although a couple embodiments of the present invention have been shown and described, it will be appreciated by those skilled in the art that changes may be made in these embodiments without departing from the principles and spirit of the invention, the scope of which is defined in the claims and their equivalents.

1. A method of monitoring an embedded system, the method comprising:
identifying programs to be monitored;
specifying a delta time within which each identified program will check-in;
specifying a remedial action to be taken in the event the identified program fails to check-in within the delta time;
for each identified program periodically determining whether the time of the last check-in is greater than a current time minus the delta time; and
when the time of the last check in for any identified program is less than a current time minus the delta time for that program executing the remedial action associated with that program.

2. A method, as set forth in claim 1, further comprising:
identifying a second and third remedial action;
the second time the last check in for any identified program is less than a current time minus the delta time for that program, executing the second remedial action associated with that program; and
the third time the last check in for any identified program is less than a current time minus the delta time for that program to be monitored executing the third remedial action associated with that program.

3. A method, as set forth in claim 1, wherein the remedial action comprises restarting the system.

4. A method, as set forth in claim 2, wherein first remedial action comprises restarting he identified program.

5. A method, as set forth in claim 4, wherein the second remedial action comprises restarting the system.

6. A method, as set forth in claim 4, wherein the third remedial action comprises halting the system.

7. A method, as set forth in claim 6, wherein the third remedial action further comprises indicating that the system is no longer functional.

8. A method as set forth in claim 7, wherein indicating the system is no longer function comprises illuminating an indicator.

9. A method as set forth in claim 1, wherein the remedial action comprises illuminating an indicator to indicate that the system is not functioning correctly.

10. A method, as set forth in claim 1, further comprising:
registering each identified program by creating an entry containing an identifier of the identified program, the delta time for the identified program and an indication of the first remedial action.

11. A method, as set forth in claim 10, wherein the entry is a key in a registry associated with an operating system of the embedded system.

12. A method, as set forth in claim 1, wherein the step of specifying a remedial action comprises:
for each identified program creating a list of executable files which, when executed perform remedial actions; and
creating a pointer, for each identified program, into each list which may be modified to point to individual entries in the list.

13. A method, as set forth in claim 1, wherein the remedial action comprises rebooting the system and wherein the method further comprises:
for each identified program, determining a number of times that rebooting as a remedial measure is acceptable;
for each identified program, incrementing a counted associated with the identified program each time the system is rebooted due to the failure of that identified program to check-in; and
halting system operation when the number of times the system is rebooted due to the failure of an identified program to check-in exceeds the number determined for that identified program.

14. A method, as set forth in claim 13, wherein the counters are reset based on a user specified condition.

15. A method, as set forth in claim 14, wherein the user specified condition is expiration of a predetermined period of time.

16. An embedded system comprising:
a processor responsive to programs including an operating system;
a watched memory location;
at least one watched program that stores an identifier and a delta time in the watched memory location, the watched program being configured to periodically write a timestamp associated with the identifier in the watched memory, the period being less than or equal to the delta time; and
a watchdog program that periodically checks for failures in the watched programs by comparing the timestamps for each watched program to the difference of a current time and the delta time for that watched program, when a failure is identified the watchdog program executes a remedial action associated with the watched program.

17. An embedded system, as set forth in claim 16, wherein the remedial action is a restart of the system and the watched program is configured to provide an maximum number of failures; and
the watchdog program includes counters that keep track of the number of failures for each watched program and when the number of failures for any watched program is equal to or exceeds that watched programs maximum number, the watchdog program halts the embedded system.

18. An embedded system, as set forth in claim 17, wherein the watchdog program resets the counters upon the expiration of a predetermined time.

19. An embedded system, as set forth in claim 17, wherein the watchdog program resets the counters each day.

20. An embedded system, as set forth in claim 16, wherein a list of remedial actions is defined for each watched program; and
the watchdog program includes counters that keep track of the number of failures for each watched program, the counters being used to select a different remedial action from the list of remedial action to execute upon each failure.

21. An embedded system, as set forth in claim 20, wherein the remedial actions include: restarting the watched program; illuminating an indicator; restarting the system; and halting the operation of the system.

22. An embedded system, as set forth in claim 16, wherein the watched memory location comprises a registry associated with the operating system.

23. An embedded-system as set forth in claim 16, wherein the watchdog program is encoded as a service.

24. An embedded system as set forth in claim 16, wherein the watched programs are configured by linking to a common dynamic linked library that contains registration and check-in routimes, the registration routimes controlling the storing of identifiers and delta times in the watched memory location, and the check-in routimes controlling the periodic writing of time stamps.

25. A headless embedded system comprising:
at least one watched program that stores an identifier and a delta time in a watched memory location, the watched program being configured to periodically write a timestamp associated with the identifier in the watched memory, the period being less than or equal to the delta time; and
a watchdog means for periodically checks for failures in the watched programs by comparing the timestamps for each watched program to the difference of a current time and the delta time for that watched program, when a failure is identified the watchdog program executes a remedial action associated with the watched program.
